(19) United States
(12) Patent Application Publication
(10) Pub. No.: US 2024/0241909 A1
(43) Pub. Date: Jul. 18, 2024

(54) EMBED GRAPH DATABASE AS SAAS IN ANOTHER DATABASE SAAS

(71) Applicant: TigerGraph, Inc., Redwood City, CA (US)

(72) Inventors: Songting Chen, Portola Valley, CA (US); Jay Yu, Encinitas, CA (US); Yu Xu, Redwood City, CA (US)

(21) Appl. No.: 18/154,895

(22) Filed: Jan. 16, 2023

(51) Int. Cl. G06F 16/901; G06F 16/28

(52) U.S. Cl. CPC G06F 16/9024; G06F 16/287

(57) ABSTRACT

Graph capabilities are embedded as a service (e.g., a software as a service (SAAS)) into relational databases or other databases so that graph analytics can be realized and relationships can be analyzed. A seamless graph analytics experience, using a graph analytics system, is provided to a database platform. Advantages include security and advance graph analytics can be run on data in database platforms (e.g., relational databases, kv-stores, etc.) The database platform console can be used to instruct the graph analytics to be performed on the data in the database platform. The insights and results from the graph analytics may be stored in the database platform as tables and can be joined with other data of the database platform and/or used in machine learning. A user of the database platform does not have to leave that environment to perform graph analytics on the data of the database platform.

### BACKGROUND

The dominant model for organizing and storing data in a database has been a relational model. The relational model organizes data into one or more tables (or “relations”) of columns and rows. Relational databases may be provided as a service. Another type of storage that may be provided as a service is a key-value database (also referred to as a key-value store or kv-store).

A more recent database model is a graph model. Graphs represent relationships between entities. A graph database comprises vertices (also referred to as nodes), edges, and properties (also referred to as attributes). Vertices represent data, edges represent relationships between vertices, and properties are information regarding the vertices. Compared with the relational model and other models such as the kv-store, the graph model is often faster for associative data sets and is a powerful tool for graph-like queries, such as computing the shortest path between two nodes in the graph. Other graph-like queries, such as diameter computations or community detection of a graph, can be performed over a graph database in a natural way.

Database platforms such as relational databases and kv-stores do not store data as graphs and therefore cannot readily be queried as such. These database platforms do not provide graph analytics.

It is with respect to these and other considerations that the various aspects and embodiments of the present disclosure are presented.

### SUMMARY

Systems and methods are provided that embed graph capabilities as a service (e.g., a software as a service (SAAS)) into relational databases (or other databases) so that graph analytics can be efficiently realized and relationships can be efficiently analyzed.

In an embodiment, a method comprises: creating a graph abstract to describe a relationship in a dataset of a database platform; loading the graph abstract into a graph analytics system; analyzing data of the graph abstract at the graph analytics system pursuant to a query; receiving a result of the query at the database platform from the graph analytics system; and outputting the result at the database platform.

In an embodiment, a method comprises: creating a graph comprising specifying a data mapping in a database platform, wherein the data mapping describes a relationship in a dataset of the database platform; loading the graph into a graph analytics system without a user interacting with the graph analytics system; running graph analytics on the graph at a graph analytics system; and outputting a result of the graph analytics.

In an embodiment, a system comprises: a console of a database platform configured to receive a command to create a graph abstract using a graph creation engine of the database platform to describe a relationship in a dataset of the database platform; a graph loading engine of the database platform configured to load the graph abstract into a graph analytics system; a graph query engine of the database platform configured to analyze data of the graph abstract using the graph analytics system pursuant to a query; and a storage of the database platform configured to store a result of the query from the graph analytics system.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an exemplary environment for integrating graph analytics with a database platform;

FIG. 2 is an illustration of another exemplary environment for integrating graph analytics with a database platform;

FIG. 3 is an operational flow of an implementation of a method for integrating graph analytics with a database platform;

FIG. 4 is an illustration of an implementation of an example graph analytics run;

FIG. 5 is an illustration of another exemplary environment for integrating graph analytics with a database platform; and

FIG. 6 shows an exemplary computing environment in which example embodiments and aspects may be implemented.

### DETAILED DESCRIPTION

Relational databases are used to query relational data. Graph structures residing within relational database datasets (but not stored as graphs) may be analyzed as described further herein.

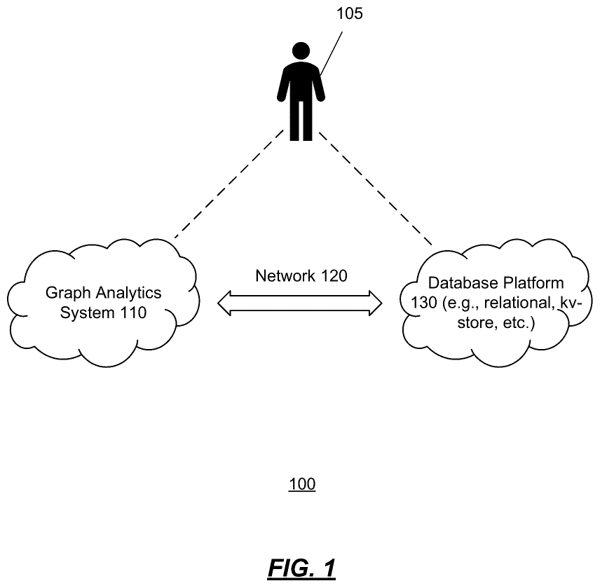

FIG. 1 is an illustration of an exemplary environment 100 for integrating graph analytics with a database platform. The environment 100 comprises a graph analytics system 110 and a database platform 130. The graph analytics system 110 and the database platform 130 are in communication with each other, e.g., via a network 120 in some implementations. The graph analytics system 110 may comprise a graph database, and the database platform 130 may comprise a relational database or kv-store, in some implementations although the database platform 130 is not limited to these data systems. Example relational databases include Google BigQuery, Snowflake, and Amazon Redshift, and an example kv-store is MongoDB.

The graph analytics system 110 may be used as a service with respect to the database platform 130, by a user 105 copying the database platform 130 to the graph analytics system 110 and then running queries on the graph analytics system 110 and then copying the results (e.g., resulting data) back to the database platform 130 from the graph analytics system 110. In this manner, the user 105 has to use both the graph analytics system 110 and the database platform 130 and move data back and forth between the graph analytics system 110 and the database platform 130 which are independent of one another.

More particularly, at the graph analytics system 110, the user 105 creates a graph schema, runs a loading job based on the database platform 130 tables, runs graph algorithms and/or queries, and writes the results back to the database platform 130. Thus, the user 105 views the tables on the database platform 130 and creates loading jobs and queries at the graph analytics system 110. In this manner, the user 105 has to work with separate consoles on both the graph analytics system 110 and the database platform 130. This may be an undesirable user experience and management experience because it is complex and time consuming, and not efficient.

As described further herein, graph processing capabilities are provided as a service into relational databases, kv-stores, etc. (e.g., any database platform) so relationships among the data can be analyzed efficiently. Thus, as described further herein, a graph analytics system is embedded as a service (e.g., a software as a service (SAAS)) into a database platform, such that relationships (e.g., graph shapes) within the database platform can be analyzed efficiently.

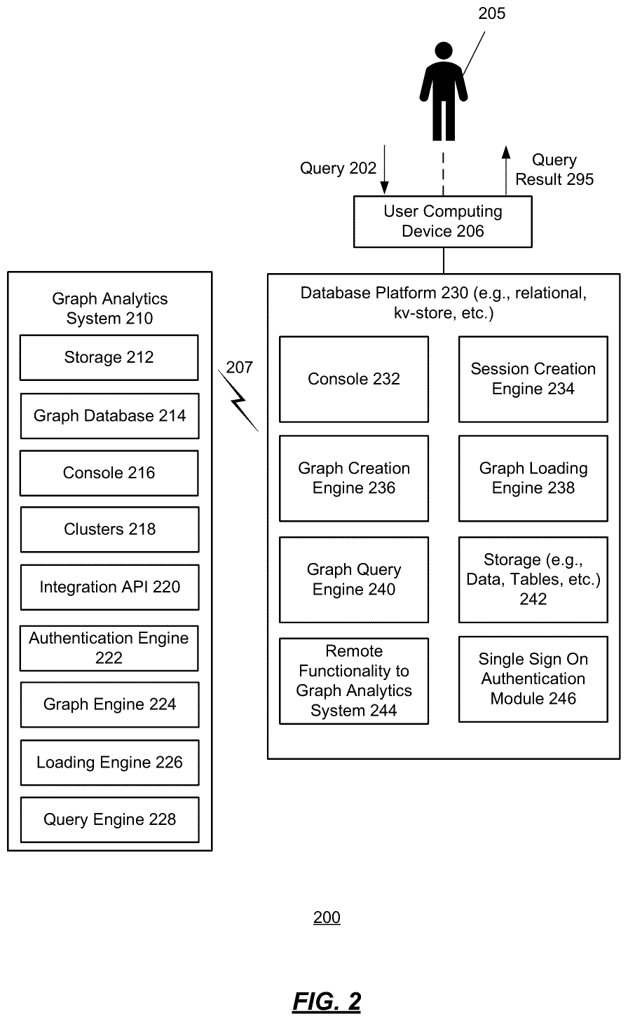

FIG. 2 is an illustration of another exemplary environment 200 for integrating graph analytics with a database platform. A seamless graph analytics experience, using a graph analytics system 210, is provided to a user 205 of a database platform 230 (e.g., a relational database, a kv-store, etc.) as described further herein.

The environment 200 may comprise a graph analytics system 210 and a database platform 230 that may be in communication with one another through a network 207. A user computing device 206 may also be provided for a user 205 to communicate with the user computing device 206, e.g., through a network such as the network 207 or another network. In some implementations, the graph analytics system 210, the database platform 230, and the user computing device 206 may be in communication with one another.

In some implementations, the user 205 may submit a query 202 to the database platform 230 (e.g., via the user computing device 206) and receive a query result 295 in response. The user 205 (e.g., a developer, an administrator, another computing device, etc.) may interact with the user computing device 206. The user computing device 206 may provide a query 202 to the database platform 230 (e.g., a console 232 of the database platform 230), and the database platform 230 may return a query result 295 to the user computing device 206. In some implementations, the user computing device 206 may be comprised within, or integral to, the database platform 230, or vice versa, and they may be in communication with each other without a network connection. The system 200 illustrates the user computing device 206 separate from the database platform 230 for ease of description, though it is contemplated that the user computing device 205 may be comprised within the database platform 230 or even the graph analytics system 210 depending on the implementation.

The network 207 may be a variety of network types including, but not limited to, the public switched telephone network (PSTN), a cellular telephone network, and a packet switched network (e.g., the Internet). In some implementations, the graph analytics system 210, the database platform 230, and the user computing device 206 may be in communication with one another variously through more than one network or network type. Although only one graph analytics system 210, one database platform 230, and one user computing device 206 are shown in FIG. 2, there is no limit to the number of graph analytics systems, database platforms, and user computing devices that may be supported.

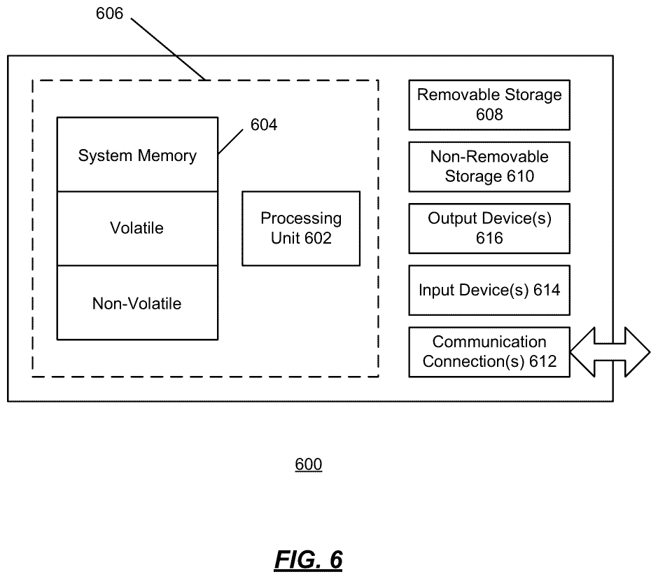

The graph analytics system 210, the database platform 230, and the user computing device 206 may each be implemented using a variety of computing devices such as smartphones, desktop computers, laptop computers, tablets, set top boxes, vehicle navigation systems, and video game consoles. Other types of computing devices may be supported. A suitable computing device is illustrated in FIG. 6 as the computing device 600.

The graph analytics system 210 comprises a storage 212 (e.g., a computer memory or storage) and a graph database 214. In some implementations, the graph database 214 may be comprised within the storage 212 or may be stored distributedly among one or more servers (not shown), such that data of the graph database is partitioned (i.e., distributed) among the storage of the servers in which case the graph database 214 is a distributed graph with its data spread among the storage of multiple servers. Queries, such as a query 202 for example, can be written to analyze graph data using the graph analytics system 210.

The graph analytics system 210 further comprises a console 216, clusters 218, an integration application programming interface (API) 220, an authentication engine 222, a graph engine 224, a loading engine 226, and a query engine 226, each configured to perform as described further herein.

The database platform 230 comprises a console 232, a session creation engine 234, a graph creation engine 236, a graph loading engine 238, a graph query engine 240, a storage 242 (e.g., a computer memory or storage), remote functionality to the graph analytics system 244, and a single sign on authentication module 246, each configured to perform as described further herein. In some implementations, the graph creation engine 236, the graph loading engine 238, and the graph query engine 240 call the corresponding APIs in the graph analytics system 210. Thus, in some implementations, the engines 236, 238, 240 may be considered to be APIs. For example, the database platform 230 calls the APIs of the graph analytics system 210 to create graph schemas, as described further herein.

A user 205 of the database platform 230 can use the graph analytics of the graph analytics system 210 directly from the console 232 of the database platform 230 without leaving the database platform 230 environment. As described further herein, the graph analytics is provided as an embedded service in the database platform 230. In this manner, graph analytics is managed from the console 232 of the database platform 230. In an implementation, a user interface is provided in the console 232 that is configured to receive a command from the user 205 (e.g., via the user computing device 206) that performs graph analytics using the graph analytics system 210. The user 205 does not need to log into the graph analytics system 210 to perform graph analysis (e.g., of the data of the database platform 230).

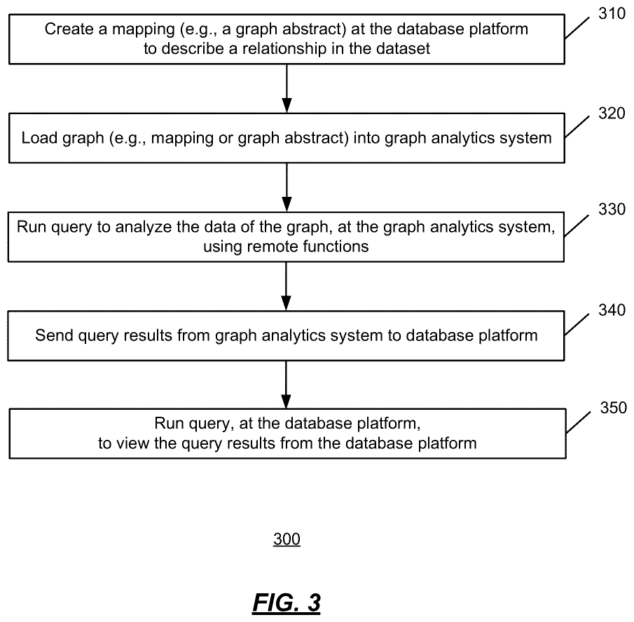

FIG. 3 is an operational flow of an implementation of a method 300 for integrating graph analytics with a database platform. The method 300 may performed in the environment 200 in some implementations.

At 310, a mapping in created in the database platform (e.g., in the relational database in some implementations) to describe a relationship in the dataset. For example, a graph abstract (an abstraction of the data) is created, using the graph creation engine 236, based on the local data in the storage 242 of the database platform 230.

At 320, the graph is loaded into the graph analytics system, e.g., by the graph loading engine 238. In an implementation, the graph loading engine 238 (e.g., an API) calls the corresponding API in the graph analytics system 210. In this manner, the data is ported from storage of the database platform into the storage (e.g., a database) of the graph analytics system, such as the storage 212 of the graph analytics system 210. This operation is performed without the user taking any action. Moreover, both operations 310 and 320 can be performed via the console 232 without the user 205 having to log into the graph analytics system 210.

At 330, a query is run (e.g., at the query engine 228) to analyze the data (e.g., the relationship data) that was received at graph analytics system from the database platform (e.g., from the graph query engine 240, which in some implementations may be a graph query API). The query may be received at the graph analytics system in the form of a command from the database platform. As described further herein, remote functions (e.g., via the remote functionality to graph analytics system 244) are used to translate commands (e.g., in operations 310, 320, 330) to the corresponding API (e.g., of the integration API 220) for execution on the graph analytics system. This execution operation uses the remote functions to translate functionality to be performed on the graph analytics system without the user having to interact with the graph analytics system (e.g., the console of the graph analytics system).

At 340, the results of the query (the resulting data) are sent back (e.g., ported) to the database platform, where it may be stored in some implementations.

At 350, a query is run to view the results e.g., from storage of the database platform. In some implementations, the results may be used for machine learning or to join the results (e.g., in a tabular form) with other data.

Because of the use of graph abstracts, as well as the functions on the database platform 230 that allow the user 205 to define graphs, load graphs, and query the graphs on the graph analytics system 210, the user 205 does not need to use the console 216 on the graph analytics system 210. The functions are created on the database platform side and are performed on the graph analytics side. When a function is executed (e.g., a user executes the function), the function calls the database platform remote functions, which are provided as a service by the database, which acts a bridge (the database platform remote functions are implemented as a bridge), so all the requests that go through the remote functions are translated into the corresponding API to call the graph analytics system 210. Therefore, a call to create a graph on the database platform 230 will go to remote function which calls the corresponding create graph API on the graph analytics system 210, and similarly with load graph, query graph, etc., with the results being stored back to the data storage 242 of the database platform 230.

By having the graph abstractions, and the remote functions executions, the database platform 230 and the graph analytics system 210 are bridged. The abstractions, provided through the database platform 230, allow the user 205 to define what they want to analyze through the graph analytics system 210. The remote functions translate into the corresponding API for use on the graph analytics side, without the user having to do anything on the graph analytics side (e.g., interacting with the console 216 of the graph analytics system 210) to analyze a graph relationship in their dataset on the database platform 230. In this manner, graph analytics of a graph analytics system 210 can be embedded into various database services (e.g., relational databases, kv-stores, etc.)

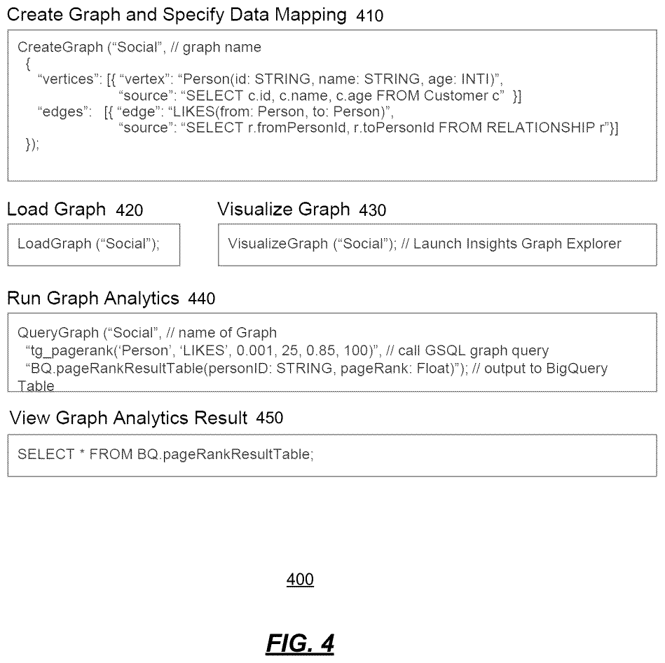

FIG. 4 is an illustration of an implementation of an example graph analytics run 400. The example graph analytics run 400 may performed in the environment 200 in some implementations.

At 410, a graph is created and a data mapping is specified (e.g., using the graph creation engine 236 and the graph engine 224). A mapping is created in the database platform (e.g., in the relational database in some implementations) to describe a relationship in the dataset. For example, a graph abstract is created based on the local data in the storage 242 of the database platform 230. Vertices and edges map to underlying tables in the database platform, in some implementations.

For example, suppose there are two tables in the relational database, one called Person and one called LIKES (to see who are friends with a person). A graph called “Social” is created where the vertices are people and the edges are the friendships (the likes). The vertices and edges map to the underlying tables. The people are coming from the vertices “source” relational table, and the friendship is coming from the edge “source” table.

An example is provided as:

```
CreateGraph (“Social”, // graph name
  {
    “vertices”: [{ “vertex”: “Person(id: STRING, name: STRING, age:
    INTI)”,
        “source”: “SELECT c.id, c.name, c.age FROM Customer c” }]
    “edges”: [{ “edge”: “LIKES(from: Person, to: Person)”,
      “source”: “SELECT r.fromPersonId, r.toPersonId FROM
      RELATIONSHIP
      r”}]
  }); .
```

At 420, the graph is loaded (e.g., using the graph loading engine 238 and the loading engine 226).

An example is provided as:
LoadGraph (“Social”).

At 430, the graph may be visualized using the database platform 230.

An example is provided as:
VisualizeGraph (“Social”); // Launch Insights Graph Explorer.

At 440, graph analytics are run (e.g., a query is run) and a result is generated (e.g., using the graph query engine 240 and the query engine 228).

An example is provided as:
QueryGraph (“Social”, // name of Graph
   “tg_pagerank(‘Person’, ‘LIKES’, 0.001, 25, 0.85, 100)”, // call GSQL graph query
   “BQ.pageRankResultTable(personID: STRING, pageRank: Float)”); // output to BigQuery Table.

It is noted that BigQuery is an example database that may be used and is not intended to be limiting, as other databases can be used such as Snowflake, Amazon Redshift, etc., for example.

At 450, the graph analytics result may be viewed (e.g., using the console of the database platform 230 or the user computing device 206). In this manner, the graph analytics result may be outputted to the user or to an application or another system or computing device, e.g., for further use, processing, analysis, learning, storage, etc.

An example is provided as:
SELECT * FROM BQ.pageRankResultTable.

An implementation in which the graph analytics related actions are performed in the database platform 230 (via the console 232 of the database platform 230) is described. Remote functionality at the database platform 230 is used to create standard endpoints that connect to the graph analytics system 210. A user 205 can call the remote functions to interact with the graph analytics system 210 in the SQL interface (e.g., the console 232) of the database platform 230:
1. CreateGraphSchema(string)
2. CreateLoadingJob(string)
3. ExecuteLoadingJob(string)
4. ExecuteQuery(queryname, parameters, BQOutputTables).

The stored procedures, all in the database platform console 230, are used:

```
CREATE Procedure biggraph( )
Begin
  CreateGraphSchema(“create vertex person .. edge likes ..”);
  CreateLoadingJob(“create loading job j1 {
    load BQ.table1(x,x) into vertex, edge ...}”);
  ExecuteLoadingJob(“j1”);
  ExecuteQuery(“pagerank”, “person,likes”, BQ.PageRank);
  // e.g., BQ or BQML on graph features
  SELECT .. FROM BQ.Table1, BQ.PageRank WHERE ..
End
```

Another implementation in which the graph analytics related actions are performed in the database platform 230 (via the console 232 of the database platform 230) is described. Remote functionality at the database platform 230 is used to create standard endpoints that connect to the graph analytics system 210:
1. CreateGraphView(string)
2. ImportGraphView(string)
3. ExecuteQuery(queryname, parameters, BQOutputTables).

It is contemplated that an alternative is to use graph abstraction and thus hide the implementation details of the graph analytics system 210, which will work with any graph analytics system 210.

At the database platform console 230:

```
CREATE Procedure biggraph( )
Begin
  CreateGraphView(“community”,
    “create vertex person {from Person table or a query}
    create edge likes {from one table or a query}”);
  ImportGraphView(“community”);
  ExecuteQuery(“louvain”, “person,likes”, BQ.Louvain);
  // e.g., BQ or BQML on graph features
  SELECT .. FROM BQ.Table1, BQ.Louvain WHERE ..
End
```

Additionally, at the database platform console:
// returns a link to TG GraphStudio
visualize(“Person=Tom”, hops=3);
visualize(TG_Shortest_Path_Query(A, B)).

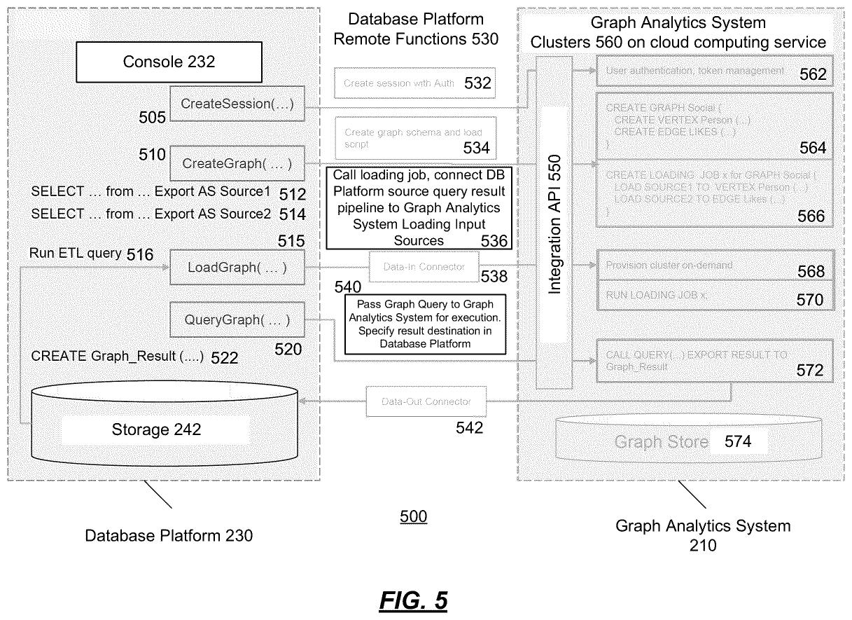

FIG. 5 is an illustration of another exemplary environment 500 for integrating graph analytics with a database platform. The environment 500 comprises a graph analytics system 210 and a database platform 230, described further herein with respect to FIG. 2. Database platform remote functions 530 are used to translate commands to the corresponding API for execution on the graph analytics system 210. As described further herein, the remote functions 530 translate functionality to be performed on the graph analytics system 210 without the user 205 having to interact with the graph analytics system 210.

The graph analytics system 210 comprises graph analytics system clusters 560 (e.g., on a cloud computing service such as google cloud platform, AWS, Azure, or any cloud vendor, for example, depending on the implementation), an integration API 550, and a graph store 574. The graph analytics system clusters 560 comprise resources that are maintained and act like a single system and enable high availability, load balancing, and parallel processing. In some implementations, the size of data from the loading job can be estimated and used to configure the initial cluster size. Additionally or alternatively, the user may specify small/median/large for example for their data as the initial start. Then the cluster may be expanded/shrunk/paused/resumed on the fly based on load and data size, for example.

The integration API 550 receives (translated) commands from the remote functions 530 for execution on the graph analytics system 210. As described further herein, remote functions are used to translate commands to the corresponding API for execution on the graph analytics system.

The graph store 574 may be configured to store the graph abstract and/or any data related to the graph analytics operations performed in conjunction with the graph analytics system 210. In some implementations, the graph store 574 may be comprised within, or may comprise, the storage 212 and/or the graph database 214.

In an implementation, a create session 505 may be instructed at the database platform 230 (e.g., via the console 232). Similarly, a create graph 510 (with commands Select . . . from . . . Export AS Source1 512 and Select . . . from . . . Export AS Source2 514), a load graph 515, and a query graph 520 may be instructed at the database platform 230. These instructions may be received from a user, application, and/or computing device (e.g., via the console 232) depending on the implementation.

The database platform remote functions 530 may comprise, depending on the implementation, a create session with authentication 532 function, a create graph schema with load script 534 function, a call loading job 536 function (e.g., with connect database platform source query result pipeline graph analytics system loading input sources), a data-in connector 538, a pass graph query 540 function (e.g., pass graph query to graph analytics system for execution, specifying result destination in the database platform), and a data-out connector 542.

Functions that can be called by an API on the graph analytics system 210 include user authentication, token management 562, create graph 564, create loading job 566, provision cluster on-demand 568, run loading job 570, and call query 572, for example, in some implementations.

The results of the call query 572 may be provided by a data-out connector 542 to the storage 242. A graph result may be queried by a create graph result 522 command. Additionally, a run ETL (extract, transform, load) query 516 may be commanded to the load graph instruction 515.

Thus, a call to create a graph on the database platform 230 will go to a remote function which calls the corresponding create graph API on the graph analytics system 210, and similarly with load graph, query graph, etc., with the results being stored back to the data storage 242 of the database platform 230.

In some implementations, security is provided with respect to integrating graph analytics with the database platform. Auto inference of security from the source system (e.g., the database platform 230) is provided to the graph analytics system 210. In some implementations, identity and access management (IAM) and/or role-based access control (RBAC) mapping may be used.

There are many access controls on the database platform side, such as with respect to relational databases. In some implementations, the corresponding access controls can be automatically inferred on the graph side because the graph is created based on the tables of the database platform (e.g., the relational database). If the user can read the table, then the vertex or the edge created on top of that table can also be accessed, and if the user does not have access to a particular table, then the corresponding vertex or edge cannot be accessed. In this manner, the security of the database platform 230 can be automatically inferred from the database platform to the graph analytics system 210 so that the user does not have to consider authentication (e.g., sign on) on both the database platform 230 and the graph analytics system 210. For example, a user can use single sign on (SSO) on the database platform side, so only one user account needs to be accessed and this allows access to the features and analytics of the graph analytic system. It is noted that there can be even finer grain access control to row or column level. For example, if a user has/(no) access to a particular row or column, they will also have/(no) access of a particular vertex/edge or attribute.

Thus, in addition to the aforementioned security advantages, advantages of systems and methods provided herein include that advance graph analytics can be run on data in database platforms such as relational databases, kv-stores, etc. The console of the database platform can be used to command and instruct the graph analytics to be performed on the data in the database platform. The insights and results from the graph analytics are stored in the database platform (e.g., in storage of the database platform) as tables in some implementations and can be joined with other data or tables of the database platform and/or used in machine learning. A user of the database platform does not have to leave that environment (e.g., does not have to go a graph analytics system) to perform graph analytics on the data of the database platform.

FIG. 6 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 6, an exemplary system for implementing aspects described herein includes a computing device, such as computing device 600. In its most basic configuration, computing device 600 typically includes at least one processing unit 602 and memory 604. Depending on the exact configuration and type of computing device, memory 604 may be volatile (such as random access memory (RAM)), non-volatile (such as read-only memory (ROM), flash memory, etc.), or some combination of the two. This most basic configuration is illustrated in FIG. 6 by dashed line 606.

Computing device 600 may have additional features/functionality. For example, computing device 600 may include additional storage (removable and/or non-removable) including, but not limited to, magnetic or optical disks or tape. Such additional storage is illustrated in FIG. 6 by removable storage 608 and non-removable storage 610.

Computing device 600 typically includes a variety of computer readable media. Computer readable media can be any available media that can be accessed by the device 600 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 604, removable storage 608, and non-removable storage 610 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of computing device 600.

Computing device 600 may contain communication connection(s) 612 that allow the device to communicate with other devices. Computing device 600 may also have input device(s) 614 such as a keyboard, mouse, pen, voice input device, touch input device, etc. Output device(s) 616 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

In an implementation, a method comprises: creating a graph abstract to describe a relationship in a dataset of a database platform; loading the graph abstract into a graph analytics system; analyzing data of the graph abstract at the graph analytics system pursuant to a query; receiving a result of the query at the database platform from the graph analytics system; and outputting the result at the database platform.

Implementations may include some or all of the following features. The dataset is comprised within a relational database or a kv-store. The graph abstract comprises a mapping. Analyzing the data is performed using remote functions. Using remote functions comprises translating commands to a corresponding API for execution on the graph analytics system. The translating commands and execution on the graph analytics system are performed without a user interacting with the graph analytics system. The method further comprises running a query at the database platform on the result received from the graph analytics system. The method further comprises authenticating a user, at the database platform, for the graph analytics system. The method further comprises providing the graph analytics system as an embedded service in the database platform. The method further comprises managing graph analytics from the database platform.

In an implementation, a method comprises: creating a graph comprising specifying a data mapping in a database platform, wherein the data mapping describes a relationship in a dataset of the database platform; loading the graph into a graph analytics system without a user interacting with the graph analytics system; running graph analytics on the graph at a graph analytics system; and outputting a result of the graph analytics.

Implementations may include some or all of the following features. The graph is a graph abstract. Vertices and edges of the graph map to tables in the database platform. The method further comprises visualizing the graph. The database platform comprises a relational database or a kv-store.

In an implementation, a system comprises: a console of a database platform configured to receive a command to create a graph abstract using a graph creation engine of the database platform to describe a relationship in a dataset of the database platform; a graph loading engine of the database platform configured to load the graph abstract into a graph analytics system; a graph query engine of the database platform configured to analyze data of the graph abstract using the graph analytics system pursuant to a query; and a storage of the database platform configured to store a result of the query from the graph analytics system.

Implementations may include some or all of the following features. The system further comprises a single sign on authentication module at the database platform configured to authenticate a user for the database platform and the graph analytics system. The system further comprises database platform remote functions configured to translate commands from the database platform for execution on the graph analytics system. The dataset is comprised within a relational database or a kv-store. Analyzing the data is performed using remote functions that translate commands to a corresponding API for execution on the graph analytics system, wherein translating the commands and execution on the graph analytics system are performed without a user interacting with the graph analytics system.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
creating a graph abstract to describe a relationship in a dataset of a database platform;
loading the graph abstract into a graph analytics system;
analyzing data of the graph abstract at the graph analytics system pursuant to a query;
receiving a result of the query at the database platform from the graph analytics system; and
outputting the result at the database platform.

2. The method of claim 1, wherein the dataset is comprised within a relational database or a kv-store.

3. The method of claim 1, wherein the graph abstract comprises a mapping.

4. The method of claim 1, wherein analyzing the data is performed using remote functions.

5. The method of claim 4, wherein the using remote functions comprises translating commands to a corresponding API for execution on the graph analytics system.

6. The method of claim 5, wherein the translating commands and execution on the graph analytics system are performed without a user interacting with the graph analytics system.

7. The method of claim 1, further comprising running a query at the database platform on the result received from the graph analytics system.

8. The method of claim 1, further comprising authenticating a user, at the database platform, for the graph analytics system.

9. The method of claim 1, further comprising providing the graph analytics system as an embedded service in the database platform.

10. The method of claim 1, further comprising managing graph analytics from the database platform.

11. A method comprising:
creating a graph comprising specifying a data mapping in a database platform, wherein the data mapping describes a relationship in a dataset of the database platform;
loading the graph into a graph analytics system without a user interacting with the graph analytics system;
running graph analytics on the graph at a graph analytics system; and
outputting a result of the graph analytics.

12. The method of claim 11, wherein the graph is a graph abstract.

13. The method of claim 11, wherein vertices and edges of the graph map to tables in the database platform.

14. The method of claim 11, further comprising visualizing the graph.

15. The method of claim 11, wherein the database platform comprises a relational database or a kv-store.

16. A system comprising:
a console of a database platform configured to receive a command to create a graph abstract using a graph creation engine of the database platform to describe a relationship in a dataset of the database platform;
a graph loading engine of the database platform configured to load the graph abstract into a graph analytics system;
a graph query engine of the database platform configured to analyze data of the graph abstract using the graph analytics system pursuant to a query; and
a storage of the database platform configured to store a result of the query from the graph analytics system.

17. The system of claim 16, further comprising a single sign on authentication module at the database platform configured to authenticate a user for the database platform and the graph analytics system.

18. The system of claim 16, further comprising database platform remote functions configured to translate commands from the database platform for execution on the graph analytics system.

19. The system of claim 16, wherein the dataset is comprised within a relational database or a kv-store.

20. The system of claim 16, wherein analyzing the data is performed using remote functions that translate commands to a corresponding API for execution on the graph analytics system, wherein translating the commands and execution on the graph analytics system are performed without a user interacting with the graph analytics system.
